(19) United States
(12) Patent Application Publication
(10) Pub. No.: US 2024/0061202 A1
(43) Pub. Date: Feb. 22, 2024

(54) OPTICAL FIBER CABLE MOUNT THAT FACILITATES CABLE INSERTION AND REMOVAL

(71) Applicant: PPC BROADBAND, INC., East Syracuse, NY (US)

(72) Inventors: Stefan DONCHEV, Milton Keynes (GB); Afzal V. ABDULSALAM, East Syracuse, NY (US); Kim ERIKSEN, Tappernøje (DK); Jerin RAJ, East Syracuse, NY (US)

(73) Assignee: PPC BROADBAND, INC., East Syracuse, NY (US)

(21) Appl. No.: 18/236,512

(22) Filed: Aug. 22, 2023

Related U.S. Application Data
(60) Provisional application No. 63/399,937, filed on Aug. 22, 2022.

(51) Int. Cl. G02B 6/44

(52) U.S. Cl. CPC G02B 6/4454; G02B 6/4455; G02B 6/44526

(57) ABSTRACT

A fiber management portion retaining portion for retaining a fiber management portion may include a first portion, and a second portion structurally configured to be movingly attached to the first portion such that the second portion may be structurally configured to selectively slide relative to the first portion. The first portion may be structurally configured to have a first portion fiber management portion attachment portion that may be structurally configured to engage a fiber management portion; and the second portion may be structurally configured to move relative to the first portion while being attached to the first portion to provide a varying amount of space for insertion of a fiber and/or cable in the second portion so as to facilitate insertion and removal of the fiber and/or cable into/from the fiber management portion retaining portion.

### CROSS-REFERENCE TO RELATED APPLICATION

This application claims the benefit of U.S. Provisional Application No. 63/399,937 filed Aug. 22, 2022, pending, the disclosure of which is hereby incorporated by reference herein in its entirety.

### BACKGROUND

The present invention relates generally to optical fiber cable management. More particularly, the present invention relates to a splice tray mounting plate in an optical fiber cable management system (for example, a management system that includes cable splicing).

Conventional optical fiber splicing systems provide only a limited amount of space to insert and route fibers in the vicinity of splice trays. Conventional optical fiber splicing systems do not provide interchangeability of components associated with routing cables near splice trays.

It may be desirable to provide a splice tray mounting plate that is adjustable to provide an adjustable amount of space available for inserting and routing fibers in systems that organize and store optical fibers before and after the splicing of the optical fibers. It may also be desirable to provide a splice tray mounting plate that has interchangeable ends that are configured to accommodate different types and/or sizes of cables.

### SUMMARY

The present disclosure provides a splice tray mounting plate that is configured to removably receive different mounting tray ends and locate the mounting tray ends in multiple positions.

Embodiments provide a fiber management mount for a fiber management portion structurally configured to facilitate insertion and removal of fiber and/or cable, that may include a body portion, and an end portion structurally configured to be attached to the body portion. The body portion may be structurally configured to have a first end and a second end; the end portion may be structurally configured to be movingly attached to the first end of the body portion such that the end portion may be structurally configured to selectively slide relative to the body portion; the body portion may be structurally configured to have a body portion fiber management portion attachment portion that may be structurally configured to engage a fiber management portion; the body portion fiber management portion attachment portion may be structurally configured to attach the fiber management portion to the body portion such that the fiber management portion may be structurally configured to pivot relative to the body portion; the body portion may be structurally configured to include an end portion receiving portion that may be structurally configured to movingly receive the end portion at the first end or the second end of the body portion; and wherein the end portion may be structurally configured to move relative to the body portion while being attached to the body portion to provide a varying amount of space for insertion of a fiber and/or cable between the end portion and the body portion so as to facilitate insertion and removal of the fiber and/or cable into/from the mount.

In particular embodiments, the fiber management portion may be structurally configured to be a fiber splice tray.

In particular embodiments, the end portion may be a first end portion, and the fiber management mount further comprises a second end portion that may be structurally configured to be movably attached to the second end of the body portion.

In particular embodiments, the body portion fiber management portion attachment portion may be structurally configured to comprise two tabs that are structurally configured to hold a portion of the fiber management portion.

In particular embodiments, the end portion comprises an end portion expansion portion, and the end portion receiving portion may be structurally configured to movingly receive the end portion expansion portion.

In particular embodiments, the end portion expansion portion may be flexible.

In particular embodiments, the end portion expansion portion may be an end portion first expansion portion, and the end portion may be structurally configured to comprise an end portion second expansion portion.

In particular embodiments, the fiber management mount may include a plurality of the end portion receiving portion, and each of the end portion receiving portions may be structurally configured to receive a protrusion extending from the end portion expansion portion.

In particular embodiments, each of the end portion expansion portion receiving portions may be configured to be a recess.

In particular embodiments, the end portion may be structurally configured to be slidingly attached to the first end of the body portion.

In particular embodiments, the body portion may be structurally configured to be attached to a fiber management device.

Embodiments provide a fiber management portion retaining portion for a fiber management portion structurally configured to facilitate insertion and removal of a fiber and/or cable that may include a first portion, and a second portion structurally configured to be attached to the first portion. The second portion may be structurally configured to be movingly attached to the first portion such that the second portion may be structurally configured to selectively slide relative to the first portion; the first portion may be structurally configured to have a first portion fiber management portion attachment portion that may be structurally configured to engage a fiber management portion; the first portion fiber management portion attachment portion may be structurally configured to attach the fiber management portion to the first portion such that the fiber management portion may be structurally configured to pivot relative to the first portion; the first portion may be structurally configured to include a second portion receiving portion that may be structurally configured to movingly receive the second portion at a first end or a second end of the first portion; and the second portion may be structurally configured to move relative to the first portion while being attached to the first portion to provide a varying amount of space for insertion of a fiber and/or cable in the second portion so as to facilitate insertion and removal of the fiber and/or cable into/from the fiber management portion.

In particular embodiments, the first portion may be structurally configured to have a first end and a second end.

In particular embodiments, the first portion may be structurally configured to be attached to a fiber management device.

In particular embodiments, the first portion may be a main body, and the second portion may be an end portion that is structurally configured to be attached to an end of the main body.

In particular embodiments, the second portion may be a first second portion, the end of the main body may be a first end of the main body, and the fiber management portion retaining portion further comprises a second second portion that may be structurally configured to be movingly attached to a second end of the main body.

In particular embodiments, the fiber management portion may be structurally configured to be a fiber splice tray.

In particular embodiments, the second portion may be structurally configured to be slidingly attached to the first portion.

Embodiments provide a fiber management portion retaining portion for a fiber management portion structurally configured to facilitate insertion and removal of a fiber and/or cable that includes a first portion, and a second portion structurally configured to be movingly attached to the first portion such that the second portion may be structurally configured to selectively slide relative to the first portion. The first portion may be structurally configured to have a first portion fiber management portion attachment portion that may be structurally configured to engage a fiber management portion; and the second portion may be structurally configured to move relative to the first portion while being attached to the first portion to provide a varying amount of space for insertion of a fiber and/or cable in the second portion so as to facilitate insertion and removal of the fiber and/or cable into/from the fiber management portion retaining portion.

In particular embodiments, the first portion fiber management portion attachment portion may be structurally configured to attach the fiber management portion to the first portion such that the fiber management portion may be structurally configured to pivot relative to the first portion.

In particular embodiments, the second portion may be structurally configured to comprise a second portion expansion portion, and the first portion may be structurally configured to comprise a plurality of second portion expansion portion receiving portions that may be structurally configured to engage the second portion expansion portion at a different location on the first portion.

In particular embodiments, the first portion may be structurally configured to have a first end and a second end.

In particular embodiments, the first portion may be structurally configured to be attached to a fiber management device.

In particular embodiments, the first portion may be a main body, and the second portion may be an end portion structurally configured to be attached to an end of the main body.

In particular embodiments, the second portion may be a first second portion, the end of the main body may be a first end of the main body, and the fiber management portion retaining portion further comprises a second second portion that may be structurally configured to be movably attached to a second end of the main body.

In particular embodiments, the fiber management portion may be structurally configured to be a fiber splice tray.

In particular embodiments, the second portion may be structurally configured to be slidingly attached to the first portion.

Various aspects of the system, as well as other embodiments, objects, features and advantages of this disclosure, will be apparent from the following detailed description of illustrative embodiments thereof, which is to be read in conjunction with the accompanying drawings.

### BRIEF DESCRIPTION OF THE DRAWINGS

FIG. 1 is a lower perspective view of an exemplary cable fixation, entry, storage, and splicing system in accordance with various aspects of the disclosure.

FIG. 2 is side view of the cable fixation, entry, storage, and splicing system of FIG. 1.

FIG. 3 is a front view of the cable fixation, entry, storage, and splicing system of FIG. 1.

FIG. 4 is a perspective view of a plurality of splice trays and an exemplary splice tray mounting plate in accordance with various aspects of the disclosure.

FIG. 5 is a perspective view of a plurality of splice trays and an exemplary splice tray mounting plate in accordance with various aspects of the disclosure.

FIG. 6 is a front perspective view of the splice tray mounting plate of FIG. 4.

FIG. 7 is a rear perspective view of the splice tray mounting plate of FIG. 4.

FIG. 8 is a front view of the splice tray mounting plate of FIG. 6 in a fully retracted position.

FIG. 9 is a front view of the splice tray mounting plate of FIG. 6 in an intermediate position.

FIG. 10 is a front view of the splice tray mounting plate of FIG. 6 in a fully extended position.

FIG. 11 is a front perspective view of an exemplary mounting plate end in accordance with various aspects of the disclosure.

FIG. 12 is a rear perspective view of the mounting plate end of FIG. 11.

FIG. 13 is a front perspective view of an alternate exemplary splice tray mounting plate in accordance with various aspects of the disclosure.

FIG. 14 is a front view of the splice tray mounting plate of FIG. 13.

FIG. 15 is a rear perspective view of an exemplary mounting plate end in accordance with various aspects of the disclosure.

FIG. 16 is a front perspective view of the mounting plate end of FIG. 15.

FIG. 17 is a front perspective view of an alternate exemplary splice tray mounting plate in accordance with various aspects of the disclosure.

FIG. 18 is a front view of the splice tray mounting plate of FIG. 17.

### DETAILED DESCRIPTION OF EMBODIMENTS

Embodiments of the disclosure provide an end portion of a fiber management mount that may be structurally configured to move relative to a body portion of the mount while being attached to the body portion to provide a varying amount of space for insertion of a fiber and/or cable between the end portion and the body portion so as to facilitate insertion and removal of the fiber and/or cable into/from the mount.

Embodiments of the disclosure provide a modular and scalable platform for managing, storage and splicing of optical fibers. Embodiments provide a number of features which separately and together provide a significantly better experience during optical fiber routing, optical fiber splicing, and subsequent management and maintenance of the system. Embodiments provide solutions to problems like expanding the capacity of the system on demand, and other problems.

Embodiments include a splice tray mounting plate that has ends that can be located in one of a plurality of positions. The plurality of positions result in an expandability that provides a cable or fiber receiving area that is variable in size. The various sizes (widths) of the splice tray mounting plate may correspond to standard widths of other devices that are structurally configured to attach to the splice tray mounting plate.

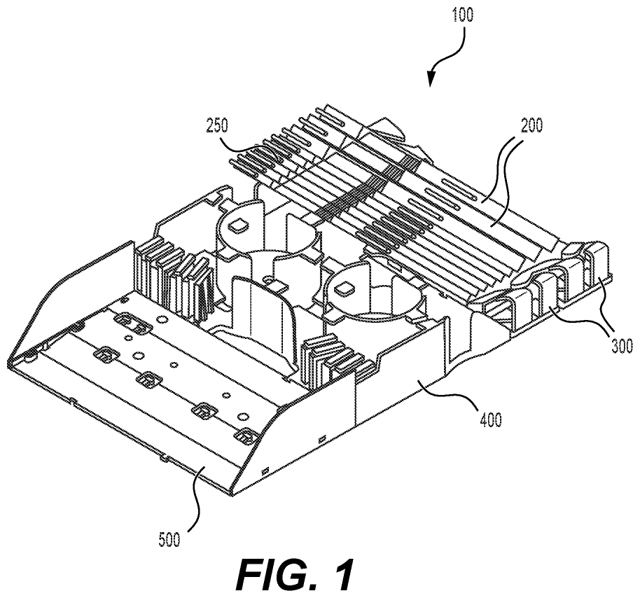

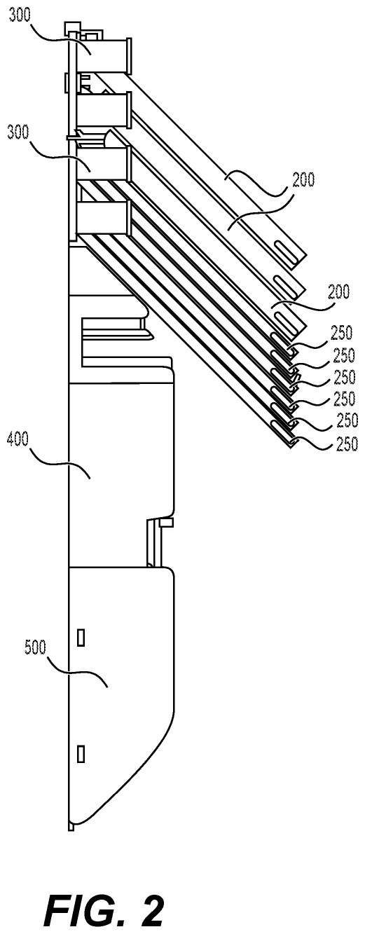

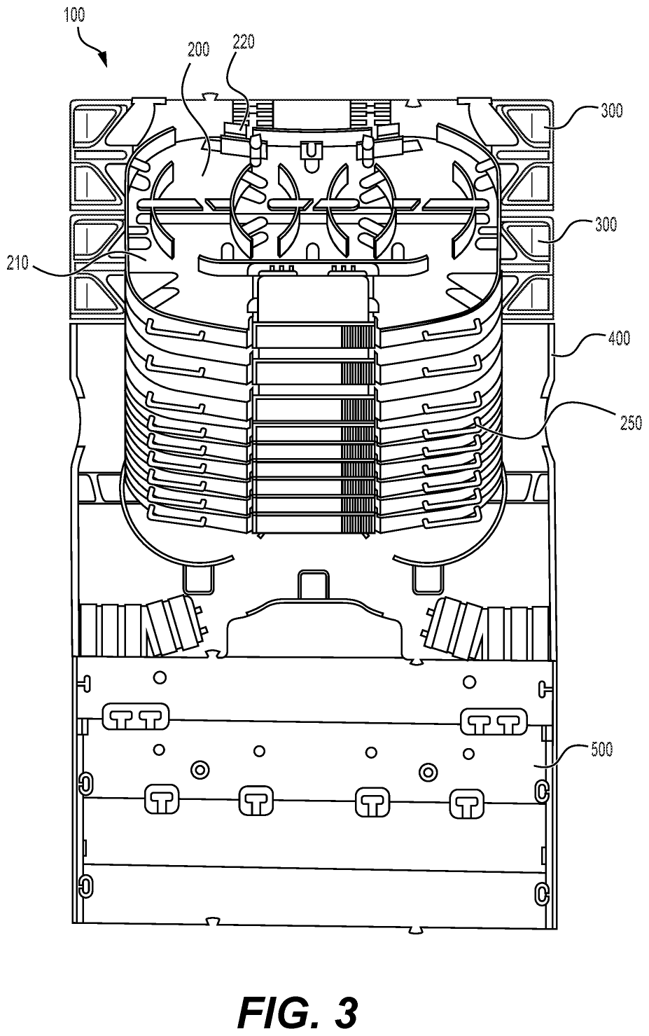

FIGS. 1-3 show an exemplary optical fiber cable fixation, entry, storage, and splicing system 100 in accordance with embodiments of the disclosure. System 100 includes, in this example, a plurality of fiber management portions such as, for example, fiber splice portions or splice trays (cassettes) 200, 250. In this example, each splice tray 200, 250 has a splicing and fiber management area 210, two connection members 220 that connect splice tray 200, 250 to a fiber management portion retaining portion such as, for example, a fiber management portion mounting plate or a splice tray mounting plate 300. This example includes two splice tray mounting plates 300 to which splice trays 200, 250 are pivotably mounted so that each splice tray 200, 250 can be pivoted upward independently from the other splice trays 200, 250. While this example uses two splice tray mounting plates 300, other examples use fewer or more than two splice tray mounting plates 300. This example includes a fiber entry and storage portion such as, for example, a fiber entry and storage plate 400 that is mounted below, and connected to, a lower-most splice tray mounting plate 300. This example includes a cable fixation portion such as, for example, a cable fixation plate 500 mounted below, and connected to, fiber entry and storage plate 400. The various components of system 100 are discussed in detail below.

In some installment locations, multiple systems 100 are mounted beside each other and/or on top of one another (with or without an intervening mounting plate) to increase density within a cabinet or other panel.

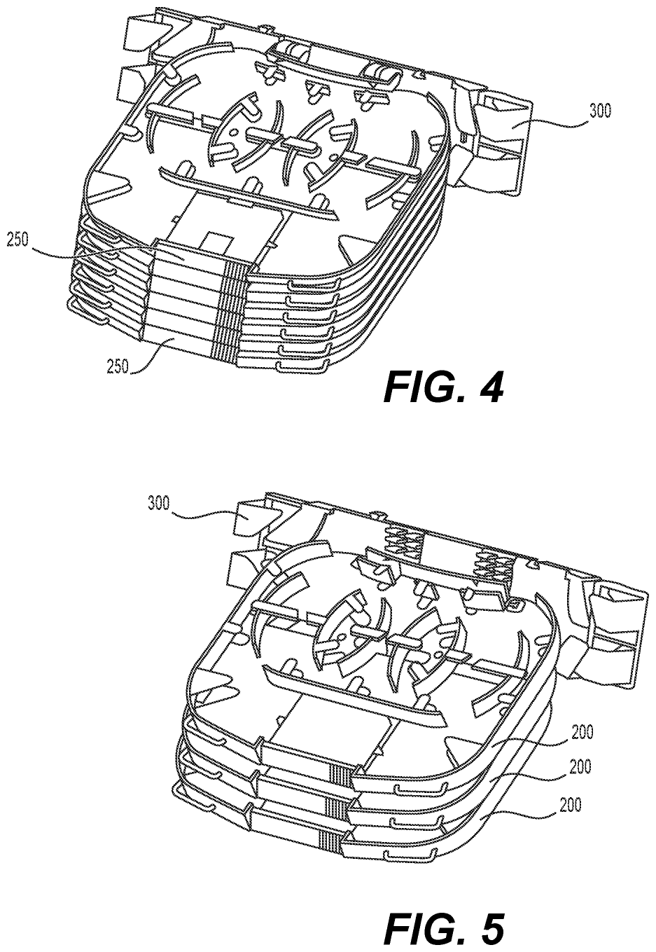

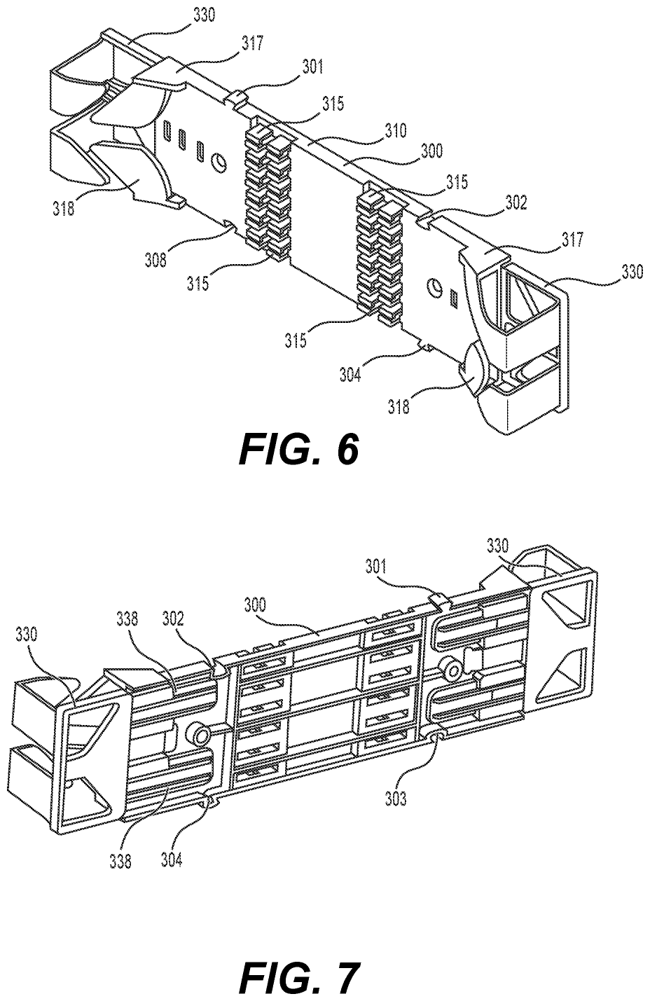

FIG. 4 is a perspective view of a splice tray mounting plate 300 to which six splice trays 250 are attached. FIG. 5 is a perspective view of a splice tray mounting plate 300 to which three splice trays 200 are attached. As can be seen in FIGS. 4 and 5, splice trays 200 are an example of splice trays that are thicker than splice trays 250. Splice trays of differing thicknesses can be accommodated by splice tray mounting plate 300 by attaching to appropriate ones of main body fiber management portion attachment portions such as, for example, mounting plate fiber splice portion attachment portions such as, for example, attachment points 315 (shown in FIG. 6).

FIGS. 6 and 7 show splice tray mounting plate 300 having a first portion such as, for example, a main portion or a main body 310 to which two removable second portions such as, for example, end portions of mounting plate ends 330 are attached. Splice tray mounting plate 300 has at each end an elevated portion 317 that includes one or more fiber guide portions such as, for example, fiber guides 318. Fiber guides 318, in this example, include two flanges separated by a passageway through which optical fibers (or other cables/wires) can be fed. Splice tray mounting plate 300 includes a plurality of attachment points 315 to which splice trays 200, 250 are attached. Attachment points 315 permit splice trays 200, 250 to be pivoted relative to splice tray mounting plate 300 while being attached to splice tray mounting plate 300. As shown in FIGS. 1-3, a plurality of splice tray mounting plates 300 can be attached to one another to provide a required number of splice trays 200, 250. As shown in FIGS. 6 and 7, main body 310 has first connection portions such as, for example, connection tabs 301, 304 and second connection portions such as, for example, connection recesses 302, 303 on edges of main body 310. Connection tab 301 is configured to be received by connection recess 303 of a second main body 310 in the case of two splice tray mounting plates 300 being stacked vertically in system 100. Two of more splice tray mounting plates 300 can be used if the number of splice trays 200, 250 required exceeds the number of splice trays 200, 250 that can be attached to one splice tray mounting plate 300. Also, connection tab 304 and connection recess 303 are configured to connect to a connection recess and a connection tab, respectively, on fiber entry and storage plate 400 (shown in FIGS. 1-3), to connect a lower most splice tray mounting plate 300 to an upper edge of fiber entry and storage plate 400 (as shown in FIGS. 1-3).

In embodiments, splice tray mounting plate 300 is expandable widthwise to accommodate different numbers/volume of cables/fibers and to facilitate the insertion and removal of cable/fibers. Main body 310 of splice tray mounting plate 300 has, in this example, three pairs of first adjustment portions such as, for example, receptacles 311, 312, 313 that are configured to receive a second adjustment portion such as, for example, a protrusion 336 on mounting plate ends 330. The width of splice tray mounting plate 300 is determined by which one of receptacles 311, 312, 313 receives protrusion 336.

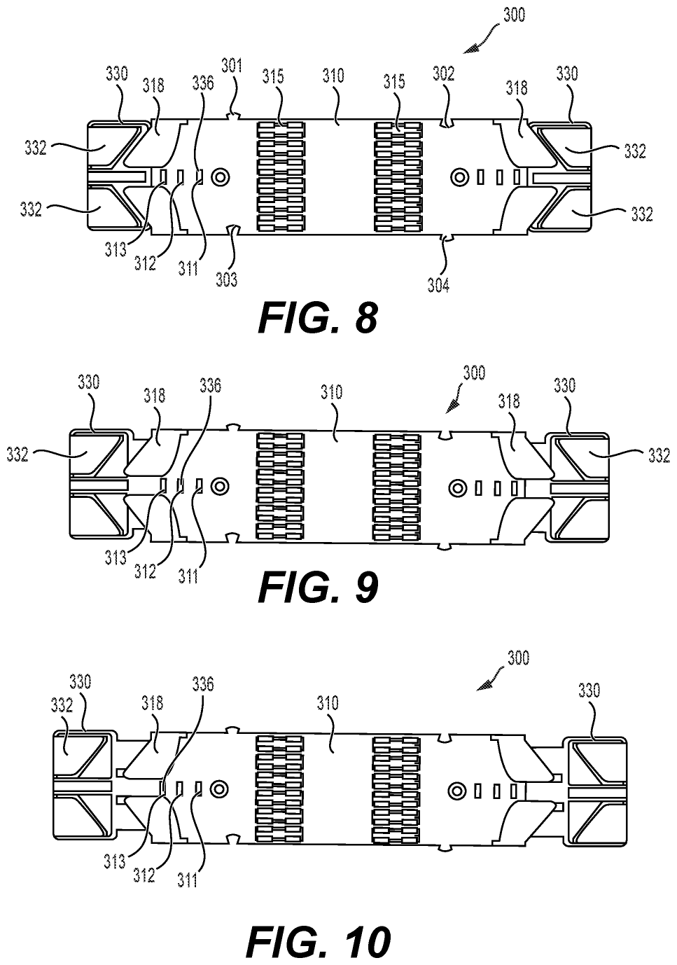

FIG. 8 is a front view of splice tray mounting plate 300 in a fully retracted position which provides the narrowest width of splice tray mounting plate 300. In this position, protrusion 336 is received in receptacle 311 and locates mounting plate ends 330 in the innermost position. This position is a normal position when cables/fibers are in an installed position. FIG. 9 is a front view of splice tray mounting plate 300 in an intermediate position which provides an intermediate width of splice tray mounting plate 300. In this position, protrusion 336 is received in receptacle 312 and locates mounting plate ends 330 in the intermediate position. This position can be helpful when a greater number of cables/fibers need to be installed. FIG. 10 is a front view of the splice tray mounting plate 300 in a fully extended position which provides a maximum width of splice tray mounting plate 300. In this position, protrusion 336 is received in receptacle 313 and locates mounting plate ends 330 in the outermost position. This position provides the most room for facilitating the insertion and removal of cables/fibers. Although main body 310 is shown with three receptacles in this example, other embodiments have fewer or more than three receptacles.

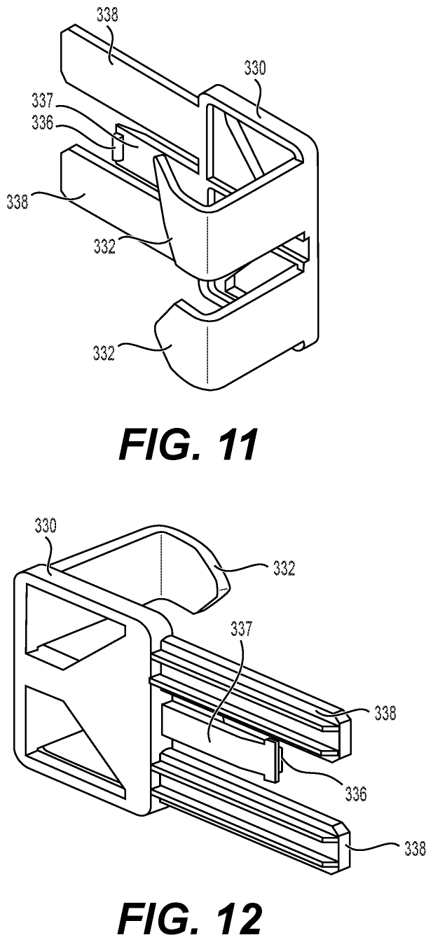

FIGS. 11 and 12 show mounting plate end 330 in more detail. In this example, mounting plate end 330 has two second portion first expansion portions such as, for example, tangs 338 that are removably received in an end of main body 310 (see FIG. 7) and slide relative to main body 310 to support mounting plate end 330 in main body 310 in the three positions shown in FIGS. 8-10. Protrusion 336 extends from a second portion second expansion portion such as, for example, a center tang 337. In embodiments, center tang 337 is flexible so as to provide an urging force to allow protrusion 336 to slide along the rear side of main body 310 and spring into receptacles 311, 312, 313. As shown in FIGS. 11 and 12, in this example, mounting plate end 330 has fiber retention portions such as, for example, two fingers 332 that work in conjunction with fiber guides 318 of main body 310 to help retain fibers (or other cables/wires).

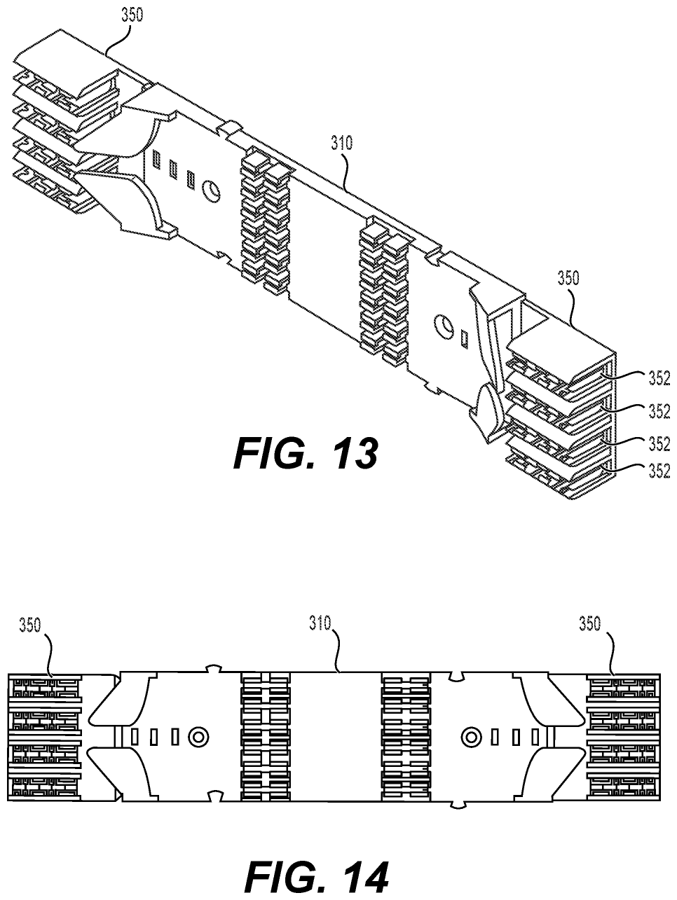

FIGS. 13 and 14 show alternate mounting plate ends removably attached to main body 310. In this example, two second portions such as, for example, mounting plate ends 350 are removably attached to main body 310. Mounting plate ends 350 are configured to receive cables of a specific thickness in reception areas such as, for example, passages 352. As with mounting plate end 330, mounting plate end 350 is provided with a protrusion that is configured to be received in receptacles 311, 312, 313 of main body 310. As a result, the location of mounting plate end 350 is adjustable.

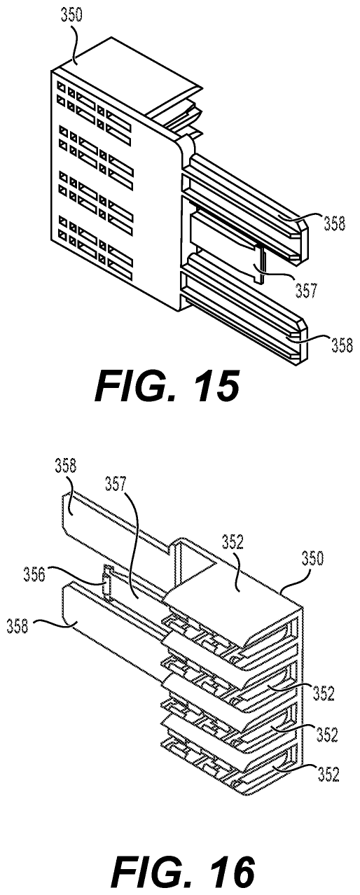

FIGS. 15 and 16 show mounting plate end 350 in more detail. In this example, mounting plate end 350 has two second portion first expansion portions such as, for example, tangs 358 that are removably received in an end of main body 310 (see FIG. 13) and slide relative to main body 310 to support mounting plate end 350 in main body 310 in the three positions shown in FIGS. 8-10. Protrusion 356 extends from a second portion second expansion portion such as, for example, a center tang 357. In embodiments, center tang 357 is flexible so as to provide an urging force to allow protrusion 356 to slide along the rear side of main body 310 and spring into receptacles 311, 312, 313. As shown in FIGS. 15 and 16, in this example, mounting plate end 350 has a plurality of passages 352 that retain fibers (or other cables/wires).

An object of the disclosure is to provide interchangeable mounting plate ends (such as, for example, mounting plate ends 330, 350) that can be removably and interchangeably attached to main body 310 to best accommodate different situations. In embodiments, mounting plate ends 330, 350 can be attached to and removed from main body 310 without removing main body 310 from the surface to which main body 310 is mounted. In embodiments, mounting plate ends 330, 350 can be attached to and removed from main body 310 without removing splice trays 200, 250 from main body 310.

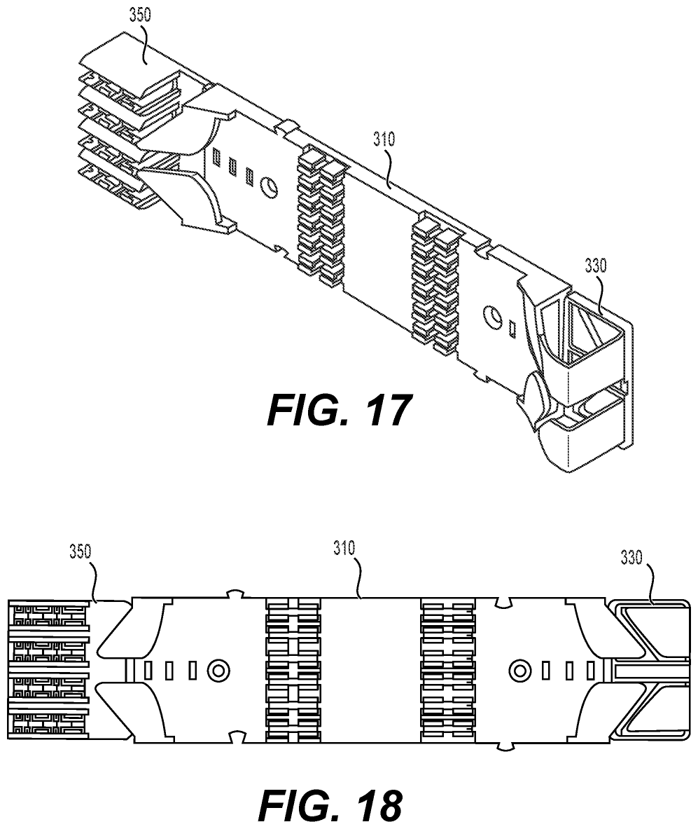

FIGS. 17 and 18 show an example in which different mounting plate ends are attached to main body 310. In this example, one mounting plate end 330 and one mounting plate end 350 are attached to main body 310.

While mounting plate ends 330, 350 in the examples shown are positioned similarly on both ends of main body 310, in other examples, the mounting plate end on one end of main body 310 can be, for example, in the innermost position (FIG. 8) and the mounting plate end on the other end of main body 310 can be, for example, in the intermediate position (FIG. 9) or the outermost position (FIG. 10). In embodiments, any combination of positions and/or mounting plate ends can be used.

Although the illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

Various changes to the foregoing described and shown structures will now be evident to those skilled in the art. Accordingly, the particularly disclosed scope of the invention is set forth in the following claims.

What is claimed is:

1. A fiber management mount for a fiber management portion structurally configured to facilitate insertion and removal of fiber and/or cable, comprising:
a body portion;
an end portion structurally configured to be attached to the body portion;
wherein the body portion is structurally configured to have a first end and a second end;
wherein the end portion is structurally configured to be attached to the first end of the body portion such that the end portion is structurally configured to selectively slide relative to the body portion;
wherein the body portion is structurally configured to have a body portion fiber management portion attachment portion that is structurally configured to engage a fiber management portion;
wherein the body portion fiber management portion attachment portion is structurally configured to attach the fiber management portion to the body portion such that the fiber management portion is structurally configured to pivot relative to the body portion;
wherein the body portion is structurally configured to include an end portion receiving portion that is structurally configured to movingly receive the end portion at the first end or the second end of the body portion; and
wherein the end portion is structurally configured to move relative to the body portion while being attached to the body portion to provide a varying amount of space for insertion of a fiber and/or cable between the end portion and the body portion so as to facilitate insertion and removal of the fiber and/or cable into/from the mount.

2. The fiber management mount of claim 1, wherein the fiber management portion is structurally configured to be a fiber splice tray.

3. The fiber management mount of claim 1, wherein the end portion is a first end portion, and the fiber management mount further comprises a second end portion that is structurally configured to be movably attached to the second end of the body portion.

4. The fiber management mount of claim 1, wherein the body portion fiber management portion attachment portion is structurally configured to comprise two tabs that are structurally configured to hold a portion of the fiber management portion.

5. The fiber management mount of claim 1, wherein the end portion comprises an end portion expansion portion, and the end portion receiving portion is structurally configured to movingly receive the end portion expansion portion.

6. The fiber management mount of claim 5, wherein the end portion expansion portion is flexible.

7. The fiber management mount of claim 5, wherein the end portion expansion portion is an end portion first expansion portion, and the end portion is structurally configured to comprise an end portion second expansion portion.

8. The fiber management mount of claim 5, wherein the fiber management mount includes a plurality of the end portion receiving portion, and each of the end portion receiving portions is structurally configured to receive a protrusion extending from the end portion expansion portion.

9. The fiber management mount of claim 8, wherein each of the end portion expansion portion receiving portions is configured to be a recess.

10. The fiber management mount of claim 1, wherein the end portion is structurally configured to be slidingly attached to the first end of the body portion.

11. The fiber management mount of claim 1, wherein the body portion is structurally configured to be attached to a fiber management device.

12. A fiber management portion retaining portion for a fiber management portion structurally configured to facilitate insertion and removal of a fiber and/or cable, comprising:
a first portion;
a second portion structurally configured to be attached to the first portion such that the second portion is structurally configured to selectively slide relative to the first portion;
wherein the second portion is structurally configured to be movingly attached to the first portion;
wherein the first portion is structurally configured to have a first portion fiber management portion attachment portion that is structurally configured to engage a fiber management portion;
wherein the first portion fiber management portion attachment portion is structurally configured to attach the fiber management portion to the first portion such that the fiber management portion is structurally configured to pivot relative to the first portion;
wherein the first portion is structurally configured to include a second portion receiving portion that is structurally configured to movingly receive the second portion at a first end or a second end of the first portion; and
wherein the second portion is structurally configured to move relative to the first portion while being attached to the first portion to provide a varying amount of space for insertion of a fiber and/or cable in the second portion so as to facilitate insertion and removal of the fiber and/or cable into/from the fiber management portion.

13. The fiber management portion retaining portion of claim 12, wherein the first portion is structurally configured to have a first end and a second end.

14. The fiber management portion retaining portion of claim 12, wherein the first portion is structurally configured to be attached to a fiber management device.

15. The fiber management portion retaining portion of claim 12, wherein the first portion is a main body, and the second portion is an end portion that is structurally configured to be attached to an end of the main body.

16. The fiber management portion retaining portion of claim 15, wherein the second portion is a first second portion, the end of the main body is a first end of the main body, and the fiber management portion retaining portion further comprises a second second portion that is structurally configured to be movingly attached to a second end of the main body.

17. The fiber management portion retaining portion of claim 12, wherein the fiber management portion is structurally configured to be a fiber splice tray.

18. The fiber management portion retaining portion of claim 12, wherein the second portion is structurally configured to be slidingly attached to the first portion.

19. A fiber management portion retaining portion for a fiber management portion structurally configured to facilitate insertion and removal of a fiber and/or cable, comprising:
a first portion;
a second portion structurally configured to be movingly attached to the first portion such that the second portion is structurally configured to selectively slide relative to the first portion;
wherein the first portion is structurally configured to have a first portion fiber management portion attachment portion that is structurally configured to engage a fiber management portion; and
wherein the second portion is structurally configured to move relative to the first portion while being attached to the first portion to provide a varying amount of space for insertion of a fiber and/or cable in the second portion so as to facilitate insertion and removal of the fiber and/or cable into/from the fiber management portion retaining portion.

20. The fiber management portion retaining portion of claim 19, wherein the first portion fiber management portion attachment portion is structurally configured to attach the fiber management portion to the first portion such that the fiber management portion is structurally configured to pivot relative to the first portion.

21. The fiber management portion retaining portion of claim 19, wherein the second portion is structurally configured to comprise a second portion expansion portion, and the first portion is structurally configured to comprise a plurality of second portion expansion portion receiving portions that are structurally configured to engage the second portion expansion portion at a different location on the first portion.

22. The fiber management portion retaining portion of claim 19, wherein the first portion is structurally configured to have a first end and a second end.

23. The fiber management portion retaining portion of claim 19, wherein the first portion is structurally configured to be attached to a fiber management device.

24. The fiber management portion retaining portion of claim 19, wherein the first portion is a main body, and the second portion is an end portion structurally configured to be attached to an end of the main body.

25. The fiber management portion retaining portion of claim 24, wherein the second portion is a first second portion, the end of the main body is a first end of the main body, and the fiber management portion retaining portion further comprises a second second portion that is structurally configured to be movably attached to a second end of the main body.

26. The fiber management portion retaining portion of claim 19, wherein the fiber management portion is structurally configured to be a fiber splice tray.

27. The fiber management portion retaining portion of claim 19, wherein the second portion is structurally configured to be slidingly attached to the first portion.
